(19) United States
(12) Patent Application Publication
(10) Pub. No.: US 2025/0019852 A1
(43) Pub. Date: Jan. 16, 2025

(54) METHOD OF CONTROLLING PROPERTIES OF ELECTROLYTIC COPPER FOIL AND MANUFACTURING THE SAME

(71) Applicants: KOREA ZINC CO., LTD., Seoul (KR); KZAM Corporation, Ulsan (KR)

(72) Inventors: Jeong Hwan KIM, Ulsan (KR); Sae Kwon HEO, Ulsan (KR); Gyun HU, Ulsan (KR)

(21) Appl. No.: 18/548,195

(22) PCT Filed: Mar. 30, 2023
(86) PCT No.: PCT/KR2023/004288

§ 371 Date: Aug. 28, 2023

(30) Foreign Application Priority Data
May 11, 2022 (KR) 10-2022-0057727

(51) Int. Cl. C25D 1/04; C25D 3/38

(52) U.S. Cl. CPC C25D 1/04; C25D 3/38

(57) ABSTRACT

A method of controlling physical properties of an electrolytic copper foil according to one embodiment of the present invention includes: controlling the physical properties of the electrolytic copper foil including elongation, tensile strength and roughness by regulating a surface glossiness of the electrolytic copper foil through addition of a surface glossiness agent. The surface glossiness is regulated within a range of 35 to 400 GU (60°).

### TECHNICAL FIELD

The present invention relates to a method of controlling physical properties of an electrolytic copper foil, and a method for manufacturing an electrolytic copper foil, which are capable of easily controlling major physical properties such as tensile strength, elongation, roughness, and the like by regulating only the surface glossiness of the electrolytic copper foil.

### BACKGROUND

Recently, as the demand for secondary batteries required for the mobile device industry such as electric vehicles and mobile phones has explosively increased, the demand for copper foils required for lithium secondary batteries having a high energy density and stability is also rapidly increasing. Accordingly, a copper foil, which is a very thin copper film used as a negative electrode current collector of a secondary battery, is attracting attention as one of the most important materials in the electronic device industry. Copper foils are usually divided into an electrolytic copper foil and a rolled copper foil depending on the manufacturing method thereof. The electrolytic copper foil and the rolled copper foil have their own advantages and disadvantages, and differs in the preferred usage thereof.

In particular, the electrolytic copper foil is continuously manufactured mainly in a roll-to-roll manner, which provides an advantage that it is possible to mass-produce electrolytic copper foils having a large width and thin thickness. Therefore, the electrolytic copper foil is mainly used in the case of a lithium secondary battery. In recent years, a copper foil having a thickness of 10 m or less is required, and in particular, a copper foil having a thickness of 8 m and a copper foil having a thickness of 6 m are mainly used.

In general, the physical properties of an electrolytic copper foil such as tensile strength, elongation, and roughness are importantly managed. In addition, the thinner the thickness of the electrolytic copper foil, the larger the influence on the physical properties of the copper foil such as tensile strength, elongation, and roughness. Therefore, the relationship between the respective physical properties is considered important.

Various physical property control methods and techniques for realizing basic physical properties of a copper foil have been reported in the related art. In particular, as the method of regulating the physical properties, there has been used a method of adding one or more various kinds of organic compound additives and complexly changing the total addition amount of the additives. For example, Korean Patent Publication No. 1571064 discloses, as a method of manufacturing an electrolytic copper foil by regulating the physical properties thereof, a technique in which a thiourea-based compound additive is used to improve the manufacturing stability and the strength of an electrolytic copper foil, and sulfonic acid, which is a compound containing sulfur atoms, or a metal salt thereof is used to improve the surface glossiness of an electrolytic copper foil. In addition, Korean Patent Publication No. 1126831 discloses a technique of manufacturing an electrolytic copper foil having a minimized relative thickness of a discontinuous layer with respect to a continuous layer by appropriately regulating the composition of an electrolyte, the current density, or the type and content of additives added to the electrolyte.

However, when these additives are used, there is a problem in that it is impossible to selectively control only one physical property of a copper foil. For example, when an additive for regulating elongation among physical properties is used, it not only maintains or improves the elongation, but also affects the change in roughness or surface glossiness, which is another physical property. Therefore, there is also a problem that the addition amount of another additive related to roughness or surface glossiness needs to be changed.

In order to solve these problems, there is a demand for a method of controlling physical properties of an electrolytic copper foil, and a method for manufacturing an electrolytic copper foil, which are capable of easily regulating major physical properties such as elongation, tensile strength, roughness, and the like within the general physical property range of an electrolytic copper foil.

### Prior Art Document

Patent Document 1: Korean Patent Publication No. 1571064
Patent Document 2: Korean Patent Publication No. 1126831

### SUMMARY

The present invention has been made to solve the above problems, and it is an object of the present invention to provide a technique capable of easily regulating major physical properties such as elongation, tensile strength, roughness, and the like within the general physical property range of an electrolytic copper foil. Another object of the present invention is to provide a technique capable of solving the problem of complexly changing the addition amount of additives, simplifying a process of controlling the physical properties of an electrolytic copper foil, and reducing the resultant process cost and additive cost.

A method of controlling physical properties of an electrolytic copper foil includes controlling the physical properties of the electrolytic copper foil including elongation, tensile strength, and roughness by regulating the surface glossiness of the electrolytic copper foil through addition of a surface glossiness agent, wherein the surface glossiness is within a range of 35 to 400 GU (60°).

The elongation is regulated according to the following Equation 1 by regulating the surface glossiness:

$$E = - 3.15 \times {10}^{- 5} \times {G}^{2} + 0.006 \times G + 7.19 \qquad Equation 1$$

where G represents the surface glossiness (GU (60°), and E represents the elongation (%).

The tensile strength is regulated according to the following Equation 2 by regulating the surface glossiness:

$$T = 1.25 \times {10}^{- 4} \times {G}^{2} - 0.104 \times G + 49.8 \qquad Equation 2$$

where G represents the surface glossiness (GU (60°)) and T represents the tensile strength (kgf/mm²).

The roughness is regulated according to the following Equation 3 by regulating the surface glossiness:

$$R = 7.59 \times {10}^{- 6} \times {G}^{2} - 0.005 \times G + 1.8 \qquad Equation 3$$

where G represents the surface glossiness (GU (60°)) and R represents the roughness (μm).

The surface glossiness agent includes at least one of thiophosphoric acid-tris-(ω-sulfopropyl)ester trisodium salt, 3-mercapto-1-propanesulfonic acid (MPS), bis-(3-sulfopropyl)-disulfide disodium salt (SPS), and thioglycolic acid, which are sulfonic acids (compounds containing sulfur atoms), or metal salts thereof.

The concentration of the surface glossiness agent is 12 to 40 ppm, preferably 18 to 28 ppm.

A method for manufacturing an electrolytic copper foil according to the present invention includes: dissolving copper ions in sulfate ions to prepare an electrolyte and adding at least one of an elongation agent for maintaining and improving elongation and a tensile strength agent for maintaining and improving tensile strength to the electrolyte; controlling the physical properties of the electrolytic copper foil according to the method of controlling physical properties of an electrolytic copper foil by adding a surface glossiness agent for improving surface glossiness; and forming the electrolytic copper foil by supplying an electric current while supplying the electrolyte containing additives to a foil manufacturing machine in which a positive plate and a negative electrode rotating drum are spaced apart from each other.

The concentration of copper ions in the electrolyte is 70 g/L to 100 g/L, and the concentration of sulfate ions is 80 g/L to 150 g/L.

The elongation agent includes at least one of carboxymethylcellulose, polyethylene glycol, hydroxyethyl cellulose (HEC), octane diol-bis-polyalkylene glycol ether, and polyglycerin, which are nonionic water-soluble polymers.

The tensile strength agent includes at least one of diethylthiourea, ethylenethiourea, acetylenethiourea, 2-thiouracil, which are thiourea-based compounds or compounds in which a thiol group is linked to a nitrogen-containing hetero ring, 2-mercapto-5-benzoimidazole sulfonic acid sodium salt, sodium 3-(5-mercapto-1-tetrazolyl)benzene sulfonate, and 2-mercapto benzothiazole.

The surface glossiness agent includes at least one of thiophosphoric acid-tris-(ω-sulfopropyl)ester trisodium salt, 3-mercapto-1-propanesulfonic acid (MPS), bis-(3-sulfopropyl)-disulfide disodium salt (SPS), and thioglycolic acid, which are sulfonic acids (compounds containing sulfur atoms), or metal salts thereof.

The concentration of the surface glossiness agent is 12 to 40 ppm, preferably 18 to 28 ppm.

According to the present invention, it is possible to easily regulate physical properties such as tensile strength, elongation, roughness, and the like by regulating only the surface glossiness of an electrolytic copper foil.

In addition, according to the present invention, by regulating only one physical property, e.g., surface glossiness, of the electrolytic copper foil, it is possible to regulate other physical properties of the electrolytic copper foil to desired values. Therefore, there is no need to complexly regulate the addition amounts of various types of additives to regulate the physical properties of the electrolytic copper foil. Accordingly, it is possible to simplify the process of controlling the physical properties of the electrolytic copper foil, and reduce the process cost and additive cost.

### BRIEF DESCRIPTION OF THE DRAWINGS

FIG. 1 is a graph showing the relationship between elongation and surface glossiness according to the present invention.

FIG. 2 is a graph showing the relationship between tensile strength and surface glossiness according to the present invention.

FIG. 3 is a graph showing the relationship between roughness and surface glossiness according to the present invention.

### DETAILED DESCRIPTION

A method of controlling physical properties of an electrolytic copper foil, and a method for manufacturing an electrolytic copper foil will now be described in detail with reference to the drawings.

The electrolytic copper foil according to the present invention can be manufactured by using an electrolyte described below.

### Electrolyte Preparation

In order to manufacture an electrolytic copper foil by electrolysis, an electrolyte is prepared by regulating the concentrations of copper ions and sulfate ions. Additives are contained in the electrolyte to regulate the basic physical properties of the electrolytic copper foil.

The concentration of copper ions in the electrolyte is 70 to 100 g/L, the concentration of sulfate ions is 80 to 150 g/L, and the concentrations of copper ions and sulfate ions vary depending on the manufacturing conditions of the electrolytic copper foil.

In this regard, the raw material of copper ions is a copper-containing raw material such as Cu powder, Cu scrap (waste electric wire, chopping Cu, etc.), copper sulfate, copper oxide, copper carbonate, or the like. All copper raw materials that can be dissolved in sulfuric acid may be used.

The electrolyte contains additives necessary for regulating the physical properties of an electrolytic copper foil. The additives typically include additives for regulating one or more physical properties of elongation, tensile strength, and surface glossiness.

An elongation agent for regulating the elongation of an electrolytic copper foil and a tensile strength agent for regulating the tensile strength of an electrolytic copper foil are added to the electrolyte.

In this regard, the elongation agent for maintaining and improving elongation includes at least one of carboxymethylcellulose, polyethylene glycol, hydroxyethyl cellulose (HEC), octane diol-bis-polyalkylene glycol ether, and polyglycerin, which are nonionic water-soluble polymers.

The tensile strength agent for maintaining and improving tensile strength includes at least one of diethylthiourea, ethylenethiourea, acetylenethiourea, 2-thiouracil, which are thiourea-based compounds or compounds in which a thiol group is linked to a nitrogen-containing hetero ring, 2-mercapto-5-benzoimidazole sulfonic acid sodium salt, sodium 3-(5-mercapto-1-tetrazolyl)benzene sulfonate, and 2-mercapto benzothiazole.

The electrolytic copper foil is manufactured by adding a surface glossiness agent for regulating the surface glossiness of an electrolytic copper foil to the electrolyte. The surface glossiness agent for improving surface glossiness includes at least one of thiophosphoric acid-tris-(ω-sulfopropyl)ester trisodium salt, 3-mercapto-1-propanesulfonic acid (IPS), bis-(3-sulfopropyl)-disulfide disodium salt (SPS), and thioglycolic acid, which are sulfonic acids (compounds containing sulfur atoms), or metal salts thereof.

The surface glossiness agent is added to the electrolyte while regulating the concentration thereof to 12 to 40 ppm, or preferably 18 to 28 ppm. If the concentration of the surface glossiness agent is higher than 40 ppm, the tensile strength and elongation of an electrolytic copper foil may be lowered, resulting in a problem in that the electrolytic copper foil is easily broken. If the concentration of the surface glossiness agent is less than 12 ppm, the curling of an electrolytic copper foil becomes severe, which makes it difficult to handle an electrolytic copper foil.

### Method for Manufacturing Electrolytic Copper Foil

In a method for manufacturing an electrolytic copper foil, an electrolyte prepared under the following conditions is supplied to a foil manufacturing machine in which a negative electrode rotating drum whose surface is made of Ti and a positive plate formed of a Dimensional Stable Electrode (DSE) electrode plate containing a platinum group element in Ti are spaced apart from each other.
Electrolyte temperature: 45 to 55 degrees C.
Flow rate of electrolyte: 1,800 to 3,500 L/hr
Current density: 4,500 to 6,500 A/m²

### Method of Controlling Physical Property of Electrolytic Copper Foil

According to one embodiment of the present invention, the surface glossiness is regulated within the range of 35 to 400 GU (60°), or preferably 120 to 250 GU (60°) by adding a surface glossiness agent, controlling the physical properties of an electrolytic copper foil such as tensile strength, elongation, and roughness.

In this case, the physical properties of the electrolytic copper foil are regulated according to Equations 1 to 3 below. Desired values of tensile strength, elongation, and roughness can be obtained by regulating only the surface glossiness, which makes it possible to easily control the physical properties of the electrolytic copper foil.

$$E = - 3.15 \times {10}^{- 5} \times {G}^{2} + 0.006 \times G + 7.19 \qquad Equation 1$$

$$T = 1.25 \times {10}^{- 4} \times {G}^{2} - 0.104 \times G + 49.8 \qquad Equation 2$$

$$R = 7.59 \times {10}^{- 6} \times {G}^{2} - 0.005 \times G + 1.8 \qquad Equation 3$$

(where G represents the surface glossiness (GU (60°)) of the electrolytic copper foil, and E, T, and R represent values of elongation (%), tensile strength (kgf/mm²), and roughness (m) of the electrolytic copper foil, respectively.)

The elongation of the electrolytic copper foil controlled by regulating the surface glossiness of the electrolytic copper foil to 120 to 250 GU (60°) is 6.5 to 9%, the tensile strength is 30 to 40 kgf/mm², and the roughness is 0.8 to 1.5 m.

According to one embodiment of the present invention, an electrolytic copper foil for a negative electrode current collector of a secondary battery can be manufactured.

Hereinafter, a process of deriving a correlation expression between the surface glossiness of the electrolytic copper foil and other physical properties according to the results of each of the experimental examples under different experimental conditions will be described in detail.

### Experimental Example 1

An electrolyte was used which has a composition containing 80 g/L of copper, 100 g/L of sulfuric acid, 10 ppm of an elongation agent (HEC), and 25 ppm of a tensile strength agent (DTE). The electrolyte was supplied to an electrolytic bath equipped with a negative electrode rotating drum (530ø×280 w) at a flow rate of 3,000 L/hr while maintaining the temperature of the electrolyte at 54 degrees C. In addition, bis-(3-sulfopropyl)-disulfide disodium salt (SPS), which is a surface glossiness agent, was added to the electrolyte while regulating the concentration thereof to 12 to 40 ppm.

In a copper foil electrolysis process, an electric current was supplied by a constant current method at a current density of 5,769 A/m², and an electrolytic copper foil having a thickness of 8 m was continuously manufactured while rotating a negative electrode rotating drum at a speed of 1.47 m/min.

### Experimental Example 2

In Experimental Example 2, the experiment was conducted under the same conditions as in Experimental Example 1, except that the concentration of the elongation agent is changed within the range of 5 to 15 ppm and the concentration of the tensile strength agent is changed within the range of 20 to 30 ppm.

### Experimental Example 3

In Experimental Example 3, the experiment was conducted under the same conditions as in Experimental Example 1, except that the concentration of copper ions in the electrolyte is changed within the range of 70 g/L to 100 g/L and the concentration of sulfate ions is changed within the range of 80 g/L to 150 g/L.

### Experimental Example 4

In Experimental Example 4, the experiment was conducted under the same conditions as in Experimental Example 1, except that the current density is changed within the range of 4,500 to 6,500 A/m² and the rotational speed of the negative electrode rotating drum is changed within the range of 1.3 to 1.6 m/min.

### Measurement of Elongation, Tensile Strength, and Roughness According to Change in the Surface Glossiness

After heat-treating the electrolytic copper foils obtained in Experimental Examples 1 to 4 at a temperature of 70 degrees C. for 18 hours, the surface glossiness, elongation, tensile strength, and roughness of the electrolytic copper foils were measured.

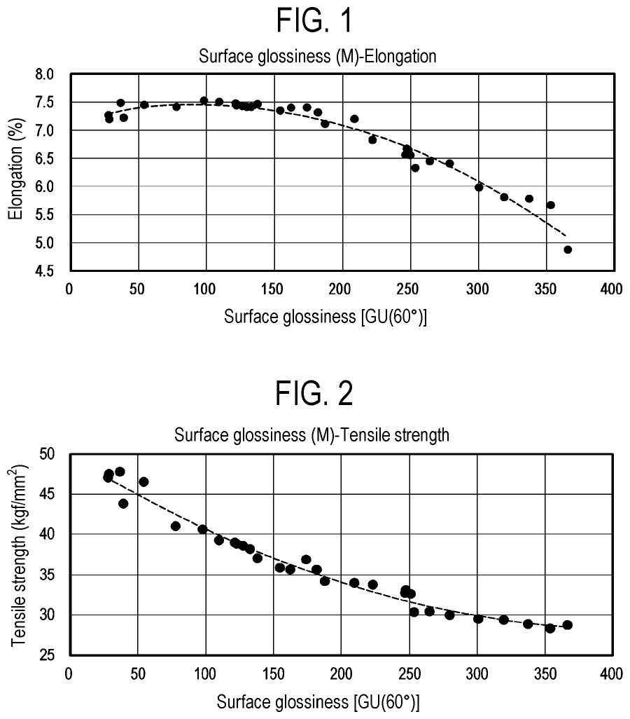

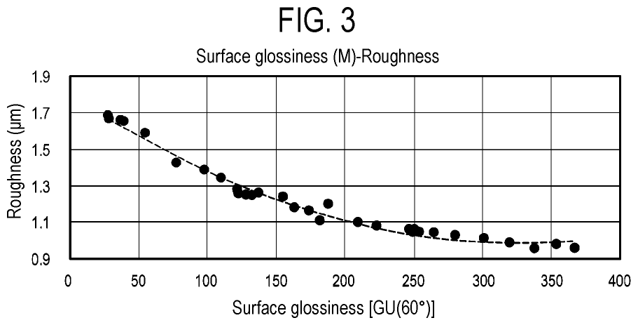

The measurement values of the elongation according to the change in the surface glossiness of the electrolytic copper foil is shown in FIG. 1, the measurement values of the tensile strength according to the change in the surface glossiness of the electrolytic copper foil is shown in FIG. 2, and the measurement values of the roughness according to the change in the surface glossiness of the electrolytic copper foil is shown in FIG. 3.

FIG. 1 is a graph showing the relationship between elongation (y-axis) and surface glossiness (x-axis) indicated by measuring the elongation of the electrolytic copper foils obtained in Experimental Examples 1 to 4. By plotting the physical property data of surface glossiness and elongation, it is possible to derive a correlation between surface glossiness and elongation when the surface glossiness is in the range of 35 to 400 GU (60°). Specifically, the correlation between surface glossiness and elongation was derived by extrapolation (a method of estimating a value outside a variable region when a function value is known only within the variable region). The correlation between surface glossiness and elongation is represented by Equation 1.

$$E = - 3.15 \times {10}^{- 5} \times {G}^{2} + 0.006 \times G + 7.19 \qquad Equation 1$$

(where G represents the surface glossiness (GU (60°)) of the electrolytic copper foil, and E represents the elongation (%) of the electrolytic copper foil.)

FIG. 2 is a graph showing the relationship between tensile strength (y-axis) and surface glossiness (x-axis) indicated by measuring the tensile strength of the electrolytic copper foils obtained in Experimental Examples 1 to 4. By plotting the physical property data of surface glossiness and tensile strength, it is possible to derive a correlation between surface glossiness and tensile strength when the surface glossiness is in the range of 35 to 400 GU (60°). Specifically, the correlation between surface glossiness and tensile strength was derived by extrapolation. The correlation between surface glossiness and tensile strength is represented by Equation 2.

$$T = 1.25 \times {10}^{- 4} \times {G}^{2} - 0.104 \times G + 49.8 \qquad Equation 2$$

(where G represents the surface glossiness (GU (60°)) of the electrolytic copper foil, and T represents the tensile strength (kgf/mm²) of the electrolytic copper foil.)

FIG. 3 is a graph showing the relationship between roughness (y-axis) and surface glossiness (x-axis) indicated by measuring the roughness of the electrolytic copper foils obtained in Experimental Examples 1 to 4. By plotting the physical property data of surface glossiness and roughness, it is possible to derive a correlation between surface glossiness and roughness when the surface glossiness is in the range of 35 to 400 GU (60°). Specifically, the correlation between surface glossiness and roughness was derived by extrapolation. The correlation between surface glossiness and roughness is represented by Equation 3.

$$R = 7.59 \times {10}^{- 6} \times {G}^{2} - 0.005 \times G + 1.8 \qquad Equation 3$$

(where G represents the surface glossiness (GU (60°)) of the electrolytic copper foil, and R represents the roughness (m) of the electrolytic copper foil.)

In order to evaluate whether the physical properties of the electrolytic copper foil can be regulated according to Equations 1 to 3, the following experiments were conducted.

### Manufacture of Electrolytic Copper Foil

### Examples 1 to 9

An electrolyte was used which has a composition containing 80 g/L of copper, 100 g/L of sulfuric acid, 10 ppm of an elongation agent (HEC), and 25 ppm of a tensile strength agent (DTE). In addition, a surface glossiness agent (SPS) was added to the electrolyte while regulating the concentration thereof to 12 to 40 ppm.

The electrolyte was supplied to an electrolytic bath equipped a negative electrode rotating drum (530ø×280 w) at a flow rate of 3,000 L/hr while maintaining the temperature of the electrolyte at 54 degrees C.

In a copper foil electrolysis process, an electric current was supplied by a constant current method at a current density of 5,769 A/m², and electrolytic copper foils having a thickness of 8 m were continuously manufactured while rotating the negative electrode rotating drum at a speed of 1.47 m/min.

### Examples 10 to 13

Electrolytic copper foils having a thickness of 8 m were manufactured under the same conditions as in Example 1, except that the concentration of the elongation agent (HEC) and the concentration of the tensile strength agent (DTE) are changed as in Table 1 below.

### Examples 14 to 17

Electrolytic copper foils having a thickness of 8 m were manufactured under the same conditions as in Example 1, except that the concentration of the copper and the concentration of the sulfuric acid are changed as in Table 1 below.

### Examples 18 to 21

Electrolytic copper foils having a thickness of 8 m were manufactured under the same conditions as in Example 1, except that the current density and the rotational speed of the negative electrode rotating drum are changed as in Table 1 below.

TABLE 1

| | | | | | | Current | |
|---|---|---|---|---|---|---|---|
| | Cu | H₂SO₄ | HEC | DTE | SPS | density | Speed |
| | (g/L) | (g/L) | (ppm) | (ppm) | (ppm) | (A/m²) | (m/min) |
| Ex 1 | 80 | 100 | 10 | 25 | 12 | 5,769 | 1.47 |
| Ex 2 | 80 | 100 | 10 | 25 | 16 | 5,769 | 1.47 |
| Ex 3 | 80 | 100 | 10 | 25 | 22 | 5,769 | 1.47 |
| Ex 4 | 80 | 100 | 10 | 25 | 23 | 5,769 | 1.47 |
| Ex 5 | 80 | 100 | 10 | 25 | 24 | 5,769 | 1.47 |
| Ex 6 | 80 | 100 | 10 | 25 | 25 | 5,769 | 1.47 |
| Ex 7 | 80 | 100 | 10 | 25 | 25.5 | 5,769 | 1.47 |
| Ex 8 | 80 | 100 | 10 | 25 | 26 | 5,769 | 1.47 |
| Ex 9 | 80 | 100 | 10 | 25 | 34 | 5,769 | 1.47 |
| Ex 10 | 80 | 100 | 12 | 28 | 18 | 5,769 | 1.47 |
| Ex 11 | 80 | 100 | 12 | 28 | 28 | 5,769 | 1.47 |
| Ex 12 | 80 | 100 | 8 | 23 | 20 | 5,769 | 1.47 |
| Ex 13 | 80 | 100 | 8 | 23 | 27 | 5,769 | 1.47 |
| Ex 14 | 75 | 95 | 10 | 25 | 19 | 5,769 | 1.47 |
| Ex 15 | 85 | 105 | 10 | 25 | 26.5 | 5,769 | 1.47 |
| Ex 16 | 75 | 95 | 10 | 25 | 17 | 5,769 | 1.47 |
| Ex 17 | 85 | 105 | 10 | 25 | 28.5 | 5,769 | 1.47 |
| Ex 18 | 80 | 100 | 10 | 25 | 15 | 6,154 | 1.57 |
| Ex 19 | 80 | 100 | 10 | 25 | 27.5 | 5,384 | 1.37 |
| Ex 20 | 80 | 100 | 10 | 25 | 21 | 6,154 | 1.57 |
| Ex 21 | 80 | 100 | 10 | 25 | 31 | 5,384 | 1.37 |

HEC: Hydroxyethyl cellulose
DTE: Diethylthiourea
SPS: Bis-(3-sulfopropyl)-disulfide-disodium salt

### Measurement of Physical Property of Electrolytic Copper Foil

After heat-treating the electrolytic copper foils manufactured in Examples 1 to 21 at a temperature of 70 degrees C. for 18 hours, the surface glossiness, elongation, tensile strength, and roughness of the electrolytic copper foils were measured and shown in Table 2 below.

### Surface Glossiness Measurement

The surface glossiness was measured in accordance with JIS B 0601, which is a surface glossiness measurement method, by cutting the electrolytic copper foil into a size of 10 cm×10 cm, irradiating the surface of the electrolytic copper foil with measurement light at an incident angle of 60° along the flow direction (MD direction) of the electrolytic copper foil, and measuring the intensity of the light reflected at a reflection angle of 60°.

### Tensile Strength/Elongation Measurement

The tensile strength and elongation were measured in accordance with JIS C 6511 by using an electrolytic copper foil tensile tester (MINOS-005: MTDI). The measurements were conducted at room temperature (25 degrees C.±10 degrees C.), a distance between chucks of 50 mm, and a displacement speed of 50 mm/min.

### Roughness Measurement

The roughness was measured in accordance with JIS B 0601 (JIS 1994), which is a roughness measurement method. The measurement was conducted in the direction perpendicular to the flow direction (MD direction) of the electrolytic copper foil by using a roughness meter (SJ-411: MITUTOYO).

Through the above measurements, the elongation, tensile strength, and roughness according to the change in surface glossiness were measured, and the elongation, tensile strength, and roughness according to the change in surface glossiness were calculated by using Equations 1 to 3. The errors between the measured values and the calculated values were calculated. The results are shown in Table 2 below. In this regard, the error values between the calculated values and the measured values of the respective physical properties were calculated by ((calculated value/measured value)×100-100) (%).

TABLE 2

| | Surface | | | | Tensile strength | | | | | |
|---|---|---|---|---|---|---|---|---|---|---|
| | glossiness | Elongation (%) | | | (kgf/mm²) | | | Roughness (μm) | | |
| | [GU (60°)] | Calculated | Measured | Error (%) | Calculated | Measured | Error (%) | Calculated | Measured | Error (%) |
| Ex 1 | 37 | 7.369 | 7.48 | −1.49 | 46.12 | 47.80 | −3.51 | 1.625 | 1.66 | −2.08 |
| Ex 2 | 98 | 7.475 | 7.52 | −0.59 | 40.81 | 40.50 | 0.76 | 1.383 | 1.39 | −0.51 |
| Ex 3 | 138 | 7.418 | 7.46 | −0.56 | 37.83 | 37.00 | 2.24 | 1.255 | 1.26 | −0.43 |
| Ex 4 | 163 | 7.331 | 7.39 | −0.80 | 36.17 | 35.60 | 1.60 | 1.187 | 1.18 | 0.56 |
| Ex 5 | 174 | 7.280 | 7.40 | −1.62 | 35.49 | 36.90 | −3.83 | 1.160 | 1.17 | −0.87 |
| Ex 6 | 182 | 7.239 | 7.30 | −0.84 | 35.01 | 35.60 | −1.65 | 1.141 | 1.11 | 2.83 |
| Ex 7 | 209 | 7.068 | 7.19 | −1.70 | 33.52 | 33.90 | −1.11 | 1.087 | 1.10 | −1.22 |
| Ex 8 | 223 | 6.962 | 6.81 | 2.23 | 32.82 | 33.70 | −2.60 | 1.062 | 1.08 | −1.63 |
| Ex 9 | 354 | 5.367 | 5.64 | −4.85 | 28.65 | 28.30 | 1.23 | 0.981 | 0.98 | 0.12 |
| Ex 10 | 121.8 | 7.453 | 7.47 | −0.22 | 38.99 | 38.9 | 0.22 | 1.304 | 1.28 | 1.84 |
| Ex 11 | 251.0 | 6.711 | 6.54 | 2.62 | 31.57 | 32.5 | −2.86 | 1.023 | 1.01 | 1.30 |
| Ex 12 | 127.6 | 7.443 | 7.42 | 0.31 | 38.56 | 38.6 | −0.09 | 1.286 | 1.26 | 2.03 |
| Ex 13 | 248.0 | 6.741 | 6.67 | 1.06 | 31.70 | 33.0 | −3.95 | 1.027 | 1.06 | −3.13 |
| Ex 14 | 123.4 | 7.451 | 7.45 | 0.01 | 38.87 | 38.8 | 0.18 | 1.299 | 1.27 | 2.25 |
| Ex 15 | 247 | 6.750 | 6.54 | 3.21 | 31.74 | 33.4 | −4.98 | 1.028 | 1.05 | −2.09 |
| Ex 16 | 110.0 | 7.469 | 7.50 | −0.42 | 39.87 | 39.2 | 1.72 | 1.342 | 1.34 | 0.14 |
| Ex 17 | 254.0 | 6.682 | 6.54 | 2.17 | 31.45 | 30.3 | 3.79 | 1.020 | 1.05 | −2.89 |
| Ex 18 | 54.8 | 7.424 | 7.45 | −0.35 | 44.48 | 46.5 | −4.35 | 1.549 | 1.59 | −2.59 |
| Ex 19 | 249.0 | 6.731 | 6.64 | 1.37 | 31.65 | 32.9 | −3.79 | 1.026 | 1.03 | −0.43 |
| Ex 20 | 129.8 | 7.438 | 7.41 | 0.38 | 38.41 | 38.4 | 0.02 | 1.279 | 1.25 | 2.31 |
| Ex 21 | 265 | 6.568 | 6.43 | 2.14 | 31.02 | 29.4 | 4.79 | 1.008 | 1.04 | −3.08 |

According to Table 2, if the surface glossiness is regulated within the range of 35 to 400 GU (60°), preferably 120 to 250 GU (60°) by adding bis-(3-sulfopropyl)-disulfide-disodium salt (SPS) as an additive to the electrolyte, the elongation, tensile strength, and roughness, which are physical properties of the electrolytic copper foil, can be calculated using Equations 1 to 3. In particular, Equations 1 to 3 can be used even if the concentration of the tensile strength agent or the elongation agent, the concentration of copper ions and sulfate ions in the electrolyte, or the current density and the rotational speed of the negative electrode rotating drum in the electrolysis process are changed. The errors are within +5% of the actual measured values. Therefore, the method can be used for actual operations.

By regulating only one physical property, e.g., surface glossiness, of the electrolytic copper foil, it is possible to regulate other physical properties of the electrolytic copper foil to desired values. Therefore, there is no need to complexly regulate the addition amounts of various types of additives to control the physical properties of the electrolytic copper foil. Accordingly, it is possible to simplify the process of controlling the physical properties of the electrolytic copper foil by regulating the surface glossiness, and reduce the process cost and additive cost.

Those skilled in the art will understand that the present invention may be embodied in other specific forms without changing its technical spirit or essential features. Therefore, the embodiments described above are exemplary in all respects and should not be construed as being limitative. The scope of the present invention is defined by the appended claims. All changes or modifications derived from the meaning and scope of the claims and equivalent concepts thereof should be construed as being included in the scope of the present invention.

1. A method of controlling physical properties of an electrolytic copper foil, comprising:
controlling the physical properties of the electrolytic copper foil including elongation, tensile strength and roughness by regulating a surface glossiness of the electrolytic copper foil through addition of a surface glossiness agent,
wherein the surface glossiness is within a range of 35 to 400 GU (60°).

2. The method of claim 1, wherein the elongation is regulated according to the following Equation 1 by regulating the surface glossiness:
$$E = - 3.15 \times {10}^{- 5} \times {G}^{2} + 0.006 \times G + 7.19 \qquad Equation 1$$
where G represents the surface glossiness (GU (60°)), and E represents the elongation (%).

3. The method of claim 1, wherein the tensile strength is regulated according to the following Equation 2 by regulating the surface glossiness:
$$T = 1.25 \times {10}^{- 4} \times {G}^{2} - 0.104 \times G + 49.8 \qquad Equation 2$$
where G represents the surface glossiness (GU (60°)) and T represents the tensile strength (kgf/mm²).

4. The method of claim 1, wherein the roughness is regulated according to the following Equation 3 by regulating the surface glossiness:
$$R = 7.59 \times {10}^{- 6} \times {G}^{2} - 0.005 \times G + 1.8 \qquad Equation 3$$
where G represents the surface glossiness (GU (60°)) and R represents the roughness (μm).

5. The method of claim 3, wherein the roughness is regulated according to the following Equation 3 by regulating the surface glossiness:
$$R = 7.59 \times {10}^{- 6} \times {G}^{2} - 0.005 \times G + 1.8 \qquad Equation 3$$
where G represents the surface glossiness (GU (60°)) and R represents the roughness (μm).

6. The method of claim 1, wherein the surface glossiness agent includes at least one of thiophosphoric acid-tris-(ω-sulfopropyl)ester trisodium salt, 3-mercapto-1-propanesulfonic acid (MPS), bis-(3-sulfopropyl)-disulfide disodium salt (SPS), and thioglycolic acid, which are sulfonic acids (compounds containing sulfur atoms), or metal salts thereof.

7. The method of claim 1, wherein a concentration of the surface glossiness agent is 12 to 40 ppm.

8. The method of claim 7, wherein a concentration of the surface glossiness agent is 18 to 28 ppm.

9. A method for manufacturing an electrolytic copper foil, comprising:
dissolving copper ions in sulfate ions to prepare an electrolyte and adding at least one of an elongation agent for maintaining and improving elongation and a tensile strength agent for maintaining and improving tensile strength to the electrolyte;
controlling the physical properties of the electrolytic copper foil according to the method of claim 1 by adding a surface glossiness agent for improving surface glossiness; and
forming the electrolytic copper foil by supplying an electric current while supplying the electrolyte containing additives to a foil manufacturing machine in which a positive plate and a negative electrode rotating drum are spaced apart from each other.

10. The method of claim 9, wherein a concentration of copper ions in the electrolyte is 70 g/L to 100 g/L, and a concentration of sulfate ions is 80 g/L to 150 g/L.

11. The method of claim 9, wherein the elongation agent includes at least one of carboxymethylcellulose, polyethylene glycol, hydroxyethyl cellulose (HEC), octane diol-bis-polyalkylene glycol ether, and polyglycerin, which are nonionic water-soluble polymers.

12. The method of claim 9, wherein the tensile strength agent includes at least one of diethylthiourea, ethylenethiourea, acetylenethiourea, 2-thiouracil, which are thiourea-based compounds or compounds in which a thiol group is linked to a nitrogen-containing hetero ring, 2-mercapto-5-benzoimidazole sulfonic acid sodium salt, sodium 3-(5-mercapto-1-tetrazolyl)benzene sulfonate, and 2-mercapto benzothiazole.

13. The method of claim 9, wherein the surface glossiness agent includes at least one of thiophosphoric acid-tris-(co-sulfopropyl)ester trisodium salt, 3-mercapto-1-propanesulfonic acid (MPS), bis-(3-sulfopropyl)-disulfide disodium salt (SPS), and thioglycolic acid, which are sulfonic acids (compounds containing sulfur atoms), or metal salts thereof.

14. The method of claim 9, wherein a concentration of the surface glossiness agent is 12 to 40 ppm.

15. The method of claim 14, wherein a concentration of the surface glossiness agent is 18 to 28 ppm.
